(19) United States
(12) Patent Application Publication
(10) Pub. No.: US 2004/0036752 A1
(43) Pub. Date: Feb. 26, 2004

(54) Ink formulation for substrate property enhancement and print quality improvement

(75) Inventors: Raouf Botros, Centerville, OH (US); Nuh-Tome Huang, Beavercreek, OH (US)

Correspondence Address: Lae Office of Barbara Joan Haushalter, 228 Bent Pines Court, Bellefontaine, OH, 43311, US

(73) Assignee: Scitex Digital Printing, Inc.

(21) Appl. No.: 10/226,022

(22) Filed: Aug. 22, 2002

(51) Int. Cl. G01D 11/00

(52) U.S. Cl. 347/100

(57) ABSTRACT

An ink additive, specifically 1,4 butanediol, is added to color inks. When 1,4-butanediol is added to the inks, curl and cockle of the printed substrate is significantly reduced without reducing surface tension of the ink. Surface tension of process color inks for some printers are kept high to eliminate color-to-color bleed and to reduce showthrough on the opposite side of the paper. The 1,4-butanediol additive provides an anti-cockling advantage without adversely affecting the surface tension of the ink.

### TECHNICAL FIELD

The present invention relates to ink jet printing and, more particularly, to an ink formulation that results in enhanced substrate properties and produces prints with improved print quality.

### BACKGROUND ART

In the ink jet printing art, a major ink/paper compatibility issue for aqueous inks is mechanical deformation of the paper. Bond papers are formed and dried in a process that locks in internal stresses. When paper fibers are wetted, the stresses are released, allowing the fibers to change position. Immediately after wetting, deformations of the paper sheet begin to grow until sufficient drying occurs to relock the fibers, usually into a deformed, objectionable state. The paper ends up being wrinkled, puckered, cockled, and curled.

A more serious problem resulting from cockle is misregistration of the drops, due to dimensional shifts in the parameter of the paper. In a process color press, drop placement of cyan, magenta, yellow and black must be precise in order to produce acceptable process color images.

Heavily inked areas lead to localized strains, called cockle, that are visible as puckered or dimpled areas. When it is severe, in addition to being aesthetically objectionable, the cockles may interfere with the printhead in the print area, smearing the image. A sheet may also develop a long-range deformation called curl, causing the sheet to roll up inwardly toward the image or even outwardly away from the image. The development of both phenomena is influenced by the media manufacturing process, ink formulation, drying process, and the bends in the paper path.

Reduction of paper cockle and curl has been a challenge in aqueous ink formulations. For example, U.S. Pat. No. 5,207,824 discloses an anti-cockling formulation using 25% 1,5 pentanediol in the ink as a means of reducing cockle and curl in the paper. The '824 patent emphasizes that a minimum of 25 of the anti-cockle agent is required in order to obtain the requisite reduction in paper cockle. However, a drawback with this approach is unacceptable show-through on the reverse side of the paper. This is particularly objectionable in book publishing, specifically when heavily inked graphics appear on one side of a paper, and text is to appear on the reverse side of the paper. Another serious problem with such an ink formulation is the deterioration in print quality in the form of edge raggedness of the print, a phenomenon again particularly objectionable in book publishing. Additional problems with such an ink formulation are prolonged drying on paper, higher viscosity of the ink which adversely affects jet stimulation, and slow drying ink on the charge leads which may cause shorts.

The '824 patent disclosed other materials which were claimed to be effective in reducing curl and cockle such as sorbitol, erythritol, neopentyl glycol, trisethane and the like. Although these materials did not reduce surface tension of the ink, they caused the eyelid to stick shut, which resulted in printhead failure. Furthermore, these materials are solids and using 20-25% additional solid content in the ink adversely effects runnability of the ink in many inkjet printers, where inks normally have less that 5% solids.

U.S. Pat. No. 5,356,464, discloses an anti-curl formulation using 1,3 diols, 1,3,5 triols, amino—1,3 diols and polyoxyalkylene derivatives, at a range of 15-30% based on the total weight of the ink. Again, most of these compounds are highly viscous glycols which would result in similar drawbacks to those mentioned above. For these compounds which are solids, adding 15-30% solids would certainly adversely affect runnability of continuous ink jet inks which are very sensitive to percent solids in the ink. Inks which are high in percent solids crystalize out on the charge plate and the orifice plate and become difficult to keep clean. As a result, crooked jets and ink jet shorts occur.

It is seen then that there is a need for an improved technique for reducing paper cockle and curl in continuous ink jet printing, particularly while maintaining surface tension of the ink.

### SUMMARY OF THE INVENTION

This need is met by the ink formulation according to the present invention, wherein an ink additive that is included in the ink formulation significantly reduces paper curl and cockle. The addition of this additive to process color ink formulations has the unexpected and previously unrealized advantage of not affecting or reducing surface tension of the ink. Substrates printed with the ink formulation having the ink additive have enhanced properties that improve the resulting print quality.

In accordance with one aspect of the present invention, an inkjet ink composition comprises a liquid vehicle, a dye, an amine, and the anti-cockling component. A pH modifier is also used to provide the necessary alkaline condition for the dye to be soluble, and to protect nickel orifice of the printer from corrosion.

Other objects and advantages of the invention will be apparent from the following description and the appended claims.

### DETAILED DESCRIPTION OF THE INVENTION

In accordance with the present invention, an ink additive, specifically 1,4 butanediol, is added to color inks. When 1,4-butanediol is added to the inks, paper curl and cockle is significantly reduced without reducing surface tension of the ink. Surface tension of process color inks for some printers are kept high by design (above 48 dynes-cm) to eliminate color-to-color bleed and to reduce showthrough on the opposite side of the paper. The 1,4-butanediol additive provides an anti-cockling advantage without adversely affecting the surface tension of the ink.

The inkjet ink composition of the present invention comprises a liquid vehicle, a dye, an amine, and an anti-cockling component. The dye in the ink composition could be direct, acid, reactive, or food colors, and are preferably at concentrations of 1-3% by weight in the powder form. The amount of dye can, of course, be varied to provide the desired color shade.

The ink jet ink composition also comprises an amine. The amine is preferably selected from the group comprising alkyls and alkanol-substituted amines such as dimethylethanolamine, triethanolamine, diethylethanolamine, and the like.

The anti-cockling component is typically 10 to 25 weight percent 1,4-butanediol. When too much 1,4-butanediol is added, the runnability of the ink can be adversely affected, in that the ink does not properly dry on the charging electrodes of the printhead, thereby causing shorts. Conversely, when too little 1,4-butanediol is added to the ink composition, the anti-cockling is not as significantly improved. The percent by weight of the 1,4-butanediol can vary between 10 and 25 weight percent to maintain runnability of the ink at desired levels, but is 15 to 20 weight percent in preferred embodiments of the ink composition.

Other additives that are optionally included in the vehicle include a corrosion inhibitor in an amount from 0 to 0.2 wt. % such as benzotriazole; and a biocide from 0 to 0.5 wt. % such as 1,2 benzoisothiazoline-3-one.

Adding the anti-cockling agent, 1,4-butanediol, to the ink, significantly reduces paper curl and cockle without reducing surface tension of the ink. U.S. Pat. No. 5,207,824 discloses an anti-cockling formulation using up to 25% 1,5-pentanediol in the ink. However, when 15% 1,5-pentanediol was added to commercially available Scitex Versapure 2003 Process Color II Black Ink, a typical ink for use in ink jet printers, the surface tension of the ink dropped from 50 to 38 dynes-cm. Furthermore, the ink with the 1,5-pentanediol caused objectionable showthrough on the opposite side of the paper and caused color-to-color bleed when the ink was used in combination with other process colors. In accordance with the present invention, however, adding 15% 1,4-butanediol to the same Scitex Versapure 2003 Process Color II Black Ink, resulted in the surface tension of the ink remaining the same at 50 dynes-cm. As a result, the showthrough was minimal and the print quality was crisp with no apparent color-to-color bleed on paper.

Another drawback in low surface tension inks in high speed printers is the tendency of the ink to leak from the printhead. When 1,4-butanediol is added to the ink, there is no indication of leaking.

The following are examples of inks formulated in accordance with the present invention.

EXAMPLE 1

| Component | Weight |
|---|---|
| M-377 Magenta Liquid | 10.0 |
| DMEA | 0.1 |
| 1,4-Eutanediol | 15.0 |
| Corrosion Inhibitor | 0.1 |
| Biocide | 0.1 |
| Deionized Water | 74.7 |

EXAMPLE 2

| Component | Weight |
|---|---|
| Acid Yellow 17 Liquid | 20.0 |
| DMEA | 0.5 |
| TEA | 0.5 |
| 1,4-Butanediol | 20.0 |
| Deionized Water | 59.0 |

EXAMPLE 3

| Component | Weight |
|---|---|
| Direct Black 19 Liquid | 33.0 |
| TEA | 0.6 |
| 1,4-Butanediol | 15.0 |
| Corrosion Inhibitor | 0.1 |
| Deionized Water | 51.3 |

EXAMPLE 4

| Component | Weight |
|---|---|
| Direct Blue 199 Liquid | 21.0 |
| TEA | 0.5 |
| 1,4-Butanediol | 15.0 |
| Biocide | 0.1 |
| Deionized Water | 63.4 |

Inks formulated according to the above examples, when printed on commercially available substrates such as Data Speed Form Bond, Pixelle Bond SX and Image Grip, showed significant improvement in cockling, even in heavily inked areas, as compared to the same paper printed with the same inks without the addition of 1,4-butanediol to the ink formulation. Curling was also significantly improved with inks formulated according to the above examples. Furthermore, the surface tension of the ink is not reduced with the addition of the 1,4-butanediol.

Each of the examples above include a pH modifier, such as TEA or DMEA. The pH modifiers are included in the ink jet ink composition to provide the necessary alkaline condition for the dye to be soluble. Maintaining the pH at levels between about 9 and 10.5 can also help to protect the nickel orifice plate from corrosion.

The invention has been described in detail with particular reference to certain preferred embodiments thereof, but it will be understood that modifications and variations can be effected within the spirit and scope of the invention.

What is claimed is:

1. An ink jet ink composition comprising a liquid vehicle, a dye, an amine, and an anti-cockling component that maintains surface tension of the ink jet ink composition.

2. An ink jet ink composition as claimed in claim 1 wherein the anti-cockling component comprises 1,4-butanediol.

3. An ink jet ink composition as claimed in claim 2 wherein the 1,4-butanediol is present in an amount of about 10 to 25 weight percent.

4. An ink jet ink composition as claimed in claim 2 wherein the 1,4-butanediol is present in an amount of about 15 to 20 weight percent.

5. An ink jet ink composition as claimed in claim 2 wherein the 1,4-butanediol reduces paper curl and cockle while maintaining surface tension of the ink at a level greater than 48 dynes-cm.

6. An ink jet ink composition as claimed in claim 1 wherein the dye is selected from the group consisting of direct, acid, reactive, or food colors.

7. An ink jet ink composition as claimed in claim 6 wherein the dye is present at a concentration of about 1-3% by weight in powder form.

8. An ink jet ink composition as claimed in claim 1 wherein the amine comprises alkyl- and alkanol-substituted amines.

9. An ink jet ink composition as claimed in claim 8 wherein the amine is selected from the group consisting of dimethylethanolamine, triethanolamine, diethylethanolamine and combinations thereof.

10. An ink jet ink composition as claimed in claim 1 further comprising a corrosion inhibitor in an amount from 0 to 0.2 weight percent.

11. An ink jet ink composition as claimed in claim 10 wherein the corrosion inhibitor comprises benzotriazole.

12. An ink jet ink composition as claimed in claim 1 further comprising a biocide in an amount from 0 to 0.5 weight percent.

13. An ink jet ink composition as claimed in claim 12 wherein the biocide comprises 1,2 benzoisothiazoline-3-one.

14. An ink jet ink composition as claimed in claim 1 further comprising a pH modifier.

15. An ink jet ink composition as claimed in claim 14 wherein the pH modifier comprises TEA.

16. An ink jet ink composition as claimed in claim 14 wherein the pH modifier comprises DMEA.

17. An ink jet ink composition as claimed in claim 14 wherein the pH is maintained at a level between about 9 and 10.5.
